(19) United States
(12) Patent Application Publication
(10) Pub. No.: US 2026/0001216 A1
(43) Pub. Date: Jan. 1, 2026

(54) MANIPULATOR ROBOT

(71) Applicant: HYUNDAI MOBIS CO., LTD., Seoul (KR)

(72) Inventor: Kyong Won MIN, Yongin-si (KR)

(73) Assignee: HYUNDAI MOBIS CO., LTD., Seoul (KR)

(21) Appl. No.: 19/008,006

(22) Filed: Jan. 2, 2025

(30) Foreign Application Priority Data
Jun. 27, 2024 (KR) 10-2024-0084693

(51) Int. Cl. B25J 9/10

(52) U.S. Cl. CPC B25J 9/1065

(57) ABSTRACT

A manipulator robot includes a first 4-bar link, a second 4-bar link to move symmetrically with the first 4-bar link, a single motor connected to one of the first 4-bar link and the second 4-bar link to supply driver power to the first 4-bar link and the second 4-bar link, and a rotation mechanism to interconnect the first 4-bar link and the second 4-bar link to transmit drive power supplied to one of the first 4-bar link and the second 4-bar link to the other of the first 4-bar link and the second 4-bar link.

### CROSS-REFERENCE TO RELATED APPLICATION(S)

This application claims the benefit under 35 USC § 119 of Korean Patent Application No. 10-2024-0084693, filed on Jun. 27, 2024, in the Korean Intellectual Property Office, the entire disclosures of which is hereby incorporated by reference for all purposes.

### BACKGROUND

### 1. Field

The present disclosure relates to a manipulator robot, and more particularly, to a manipulator robot in which a robot structure constituted by two 4-bar links is simplified using a single motor.

### 2. Description of the Related Art

A robot technology may be broadly divided into a mobile robot and a manipulator robot that may perform tasks by having an end effector at an end thereof that performs a function of a robot arm.

In the case of the manipulator robot, there is a manipulator robot that may move with 2 degrees of freedom within a plane and may move vertically at the end effector.

FIG. 1 is a view illustrating an existing 2-degree-of-freedom manipulator robot.

As shown in FIG. 1, the existing 2-degree-of-freedom manipulator robot may have an arm composed of two links L1 and L2 and two motors M1 and M2, and an end effector 110 may be mounted at an end of the second link L2.

Such a 2-degree-of-freedom manipulator robot may be utilized in various fields as follows.

### 1. Palletizing and Depalletizing

### 2. Pick and Place Operations

### 2. Vision Inspection

### 4. Fusion and Cutting

### 5. Drilling and Tapping

However, when the existing manipulator robot as mentioned above requires only 1-degree-of-freedom movement in the field, the above-mentioned manipulator robot with the 2 degrees of freedom may be seen as over-spec because (i) the 1-degree-of-freedom movement may be theoretically achieved with only one motor, (ii) it is relatively expensive, (iii) it has a complicated structure, and (iv) it is relatively difficult to control the two motors to move linearly.

### SUMMARY

The present disclosure is to address at least the above-mentioned problems and/or disadvantages and to provide at least the advantages described below. Accordingly, an aspect of the present disclosure is to provide a manipulator robot in which a robot structure constituted by two 4-bar links is simplified using a single driver.

Another aspect of the present disclosure is to provide a concrete configuration using 4-bar links, which is capable of performing stable operation when the configuration is applied to an actual product, beyond a method in which two links are controlled using a single motor, simply and only taking kinematics into consideration.

Another aspect of the present disclosure is to provide a manipulator robot capable of providing a variety of curved movements as well as linear movement by appropriately setting a length and an angle between particular links of two 4-bar links of the manipulator robot.

Additional aspects will be set forth in part in the description which follows and, in part, will be apparent from the description, or may be learned by practice of the presented embodiments of the disclosure.

In a general aspect of the disclosure, a manipulator robot includes: a first 4-bar link; a second 4-bar link configured to move symmetrically with the first 4-bar link; a single motor connected to one of the first 4-bar link and the second 4-bar link to supply driver power to the first 4-bar link and the second 4-bar link; and a rotation mechanism configured to interconnect the first 4-bar link and the second 4-bar link to transmit drive power supplied to one of the first 4-bar link and the second 4-bar link to the other of the first 4-bar link and the second 4-bar link.

The rotation mechanism may include: a first gear configured to rotate in accordance with drive power supplied to the first 4-bar link; and a second gear configured to rotate, corresponding to rotation of the first gear.

The first 4-bar link may include a first link connected to the single motor at one side thereof while being connected to the first gear at another side thereof, wherein the second 4-bar link may include a second link connected to the second gear at one side thereof and configured to move symmetrically with the first link.

Assuming that an angle formed by the first link with respect to a horizontal plane is a first angle (θ1), and an angle between the first link and the second link is a second angle (θ2), the other side of the second link may be configured to move along a linear path with respect to the one side of the first link in response to a first condition that the first link and the second link have equal length and a second condition that the second angle corresponds to double the first angle being satisfied.

Assuming that an angle formed by the first link with respect to a horizontal plane is a first angle (θ1), and an angle between the first link and the second link is a second angle (θ2), the other side of the second link may be configured to move along a curved path with respect to the one side of the first link in response to one or both of a first condition that the first link and the second link have equal length and a second condition that the second angle corresponds to double the first angle not being satisfied.

The first gear and the second gear may be connected to opposite sides of a third link, respectively, wherein the first link may be connected, at the other side thereof, to one side of the third link, together with the first gear and one side of a 1-2th link which is one link of the first 4-bar link, wherein the second link may be connected, at the one side thereof, to another side of the third link, together with the second gear and one side of a 2-2th link which is one link of the second 4-bar link.

The third link, the 1-2th link, and the 2-2th link may be disposed within a housing to constitute a signal part.

The other side of the first link and the one side of the second link may be configured to be interconnected through a combination of a revolute joint and a spherical joint.

The manipulator robot may further include a mechanical lock configured to take into consideration a phase difference caused by the first gear and the second gear, corresponding to the first link and the second link.

Each of the first gear and the second gear may include a helical gear.

The single motor may be connected to one of the first 4-bar link and the second 4-bar link via a reducer.

In another general aspect of the disclosure, a manipulator robot includes: a first 4-bar link; a second 4-bar link configured to move symmetrically with the first 4-bar link; a single motor connected to one of the first 4-bar link and the second 4-bar link to supply driver power to the first 4-bar link and the second 4-bar link; a rotation mechanism configured to interconnect the first 4-bar link and the second 4-bar link to transmit drive power supplied to one of the first 4-bar link and the second 4-bar link to the other of the first 4-bar link and the second 4-bar link; and a controller configured to control the single motor, and control the rotation mechanism to drive the first 4-bar link and the second 4-bar link to move with a 1-degree-of-freedom.

The 1-degree-of-freedom movement may include linear movement.

The rotation mechanism may include: a first gear configured to rotate in accordance with drive power supplied to the first 4-bar link; and a second gear configured to rotate, corresponding to rotation of the first gear.

The single motor may be connected to one of the first 4-bar link and the second 4-bar link via a reducer.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a view illustrating an existing 2-degree-of-freedom manipulator robot;

FIG. 2 is a view explaining a structure of a manipulator robot configured through inclusion of two 4-bar links in accordance with an embodiment of the present disclosure;

FIGS. 3 and 4 are views explaining conditions for supporting linear movement or curved movement of the manipulator robot in accordance with an embodiment of the present disclosure;

FIGS. 5 and 6 are views explaining a detailed configuration of a manipulator robot using two 4-bar links in accordance with an embodiment of the present disclosure;

FIGS. 7 and 8 are views explaining configurations of parts of a manipulator robot according to an embodiment of the present disclosure;

FIG. 9 is a view explaining a joint structure of the manipulator robot according to an embodiment of the present disclosure;

FIG. 10 is a view explaining a detailed structure of power transmission according to an embodiment of the present disclosure; and

FIGS. 11 and 12 are views illustratively showing the fields in which manipulator robots according to embodiments of the present disclosure are usable.

### DETAILED DESCRIPTION

Reference will now be made in detail to an embodiment of the present disclosure, examples of which are illustrated in the accompanying drawings, in order to enable those having ordinary knowledge in the technical field to which the present disclosure pertains to easily implement the present disclosure. However, the present disclosure may be implemented in various different forms without being limited to embodiments described herein. In order to clearly describe the present disclosure, parts irrelevant to the description are omitted from the drawings. Throughout the specification, similar parts are designated by similar reference numerals, respectively.

Throughout the specification, when a part “includes” a constituent element, the term “includes” means that another constituent element may be included, without exclusion of the other constituent element, unless particularly used otherwise.

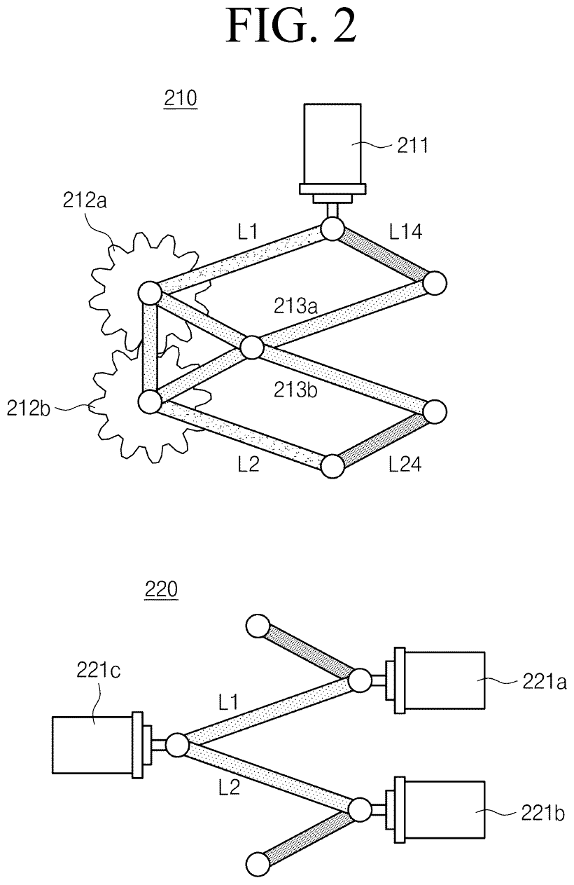

FIG. 2 is a view explaining a structure of a manipulator robot configured through inclusion of two 4-bar links in accordance with an embodiment of the present disclosure.

First, in the embodiment of the present disclosure, a structure designated by reference numeral “210” in FIG. 2 is proposed. A manipulator robot 210 according to the structure may include a first 4-bar link 213a including a first link designated by reference character “L1”, and a second 4-bar link 213b configured to move symmetrically with the first 4-bar link 213a.

Here, the “4-bar link” may also be referred to as a four-bar, and may represent a closed chain link configured to be movable most simply. As shown in FIG. 2, the 4-bar links may each form a ring shape through interconnection of four joints thereof, and may move in parallel planes, respectively. Through such configurations, the 4-bar links may stably move an end effector when the 4-bar links are applied to an actual product.

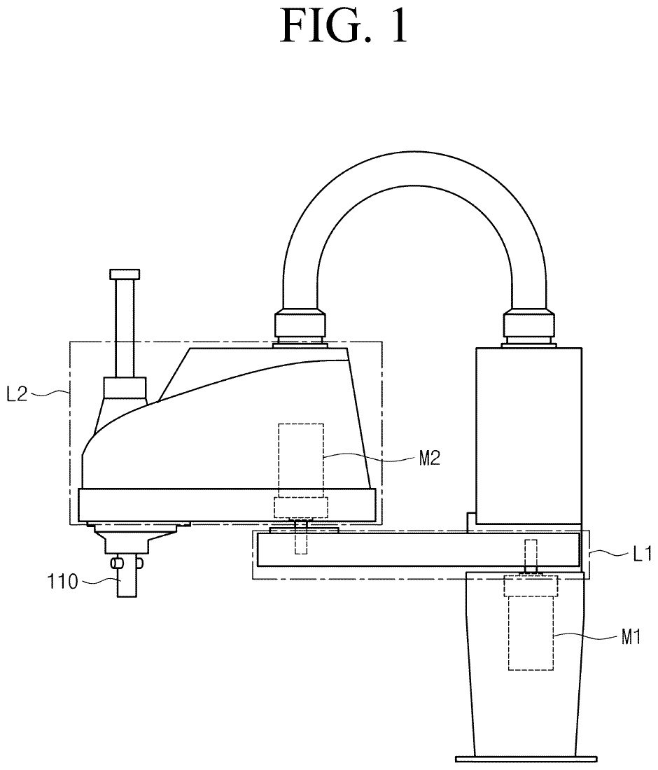

In addition, the manipulator robot 210 according to this embodiment may include a single motor 211 connected to one of the first 4-bar link 213a and the second 4-bar link 213b to supply driver power to the first 4-bar link 213a and the second 4-bar link 213b. That is, the manipulator robot 210 according to this embodiment may have an advantage in that drive power is supplied to the two 4-bar links 213a and 213b through the single motor 211, differently from the prior art of FIG. 1.

In addition, the manipulator robot 210 according to this embodiment may include a rotation mechanism 212 configured to interconnect the first 4-bar link 213a and the second 4-bar link 213b in order to transmit drive power supplied to one of the first 4-bar link 213a and the second 4-bar link 213b to the other of the first 4-bar link 213a and the second 4-bar link 213b. As the manipulator robot 210 includes the rotation mechanism 212 as described above, the manipulator robot 210 has an advantage in that manufacturing costs thereof may be reduced, and the configuration thereof may be simplified, as compared to a configuration designated by reference numeral “220” in which motors 221a, 221b, and 221c are provided at joints of links L1 and L2, respectively, to transmit drive power.

Although an example in which the single motor 211 configured to transmit drive power to the manipulator robot 210 is connected to the first 4-bar link 213a is illustrated in FIG. 2, the single motor 211 may be configured to be connected to the second 4-bar link 213b in order to first supply drive power to the second 4-bar link 213b. In the following description, however, for convenience of description, the example in which the single motor 211 is connected to the first 4-bar link 213a in order to first supply drive power to the first 4-bar link 213a will be described.

Meanwhile, in the embodiment of the present disclosure, in the configuration designated by reference numeral “210”, the rotation mechanism 212 may be configured to include a first gear 212a configured to rotate in accordance with drive power supplied to the first 4-bar link 213a, and a second gear 212b configured to rotate, corresponding to rotation of the first gear 212a. Of course, the present disclosure does not exclude utilization of various rotation mechanisms 212 configured to transmit drive power between the two 4-bar links 213a and 213b. In another example, it may be possible to transmit drive power between the two 4-bar links 213a and 213b using a belt (not shown). The manipulator robot may include a controller (e.g., a processor) configured to control the single motor 211, and control the rotation mechanism 212 to drive the first 4-bar link 213a and the second 4-bar link 213b to move with a 1-degree-of-freedom.

Meanwhile, the first 4-bar link 213a may include a first link L1 connected to the single motor 211 at one side thereof while being connected to the first gear 212a at the other side thereof, and the second 4-bar link 213b may include a second link L2 connected to the second gear 212b at one side thereof and configured to move symmetrically with the first link L1.

It is preferred that each of the first link L1, the second link L2, the first gear 212a, and the second gear 212b as described above be constituted by a rigid body. The first link L1 and the second link L2 move symmetrically with each other. For such movement, the first gear 212a and the second gear 212b may rotate in a state of being engaged with each other.

In addition, as shown in FIG. 2, the first 4-bar link 213a and the second 4-bar link 213b may include a 1-4th link L14 and a 2-4th link L24, respectively. The 1-4th link L14 and the 2-4th link L24 move without rotation to vary a distance therebetween and, as such, may support linear movement or various curved movements, as will be described later.

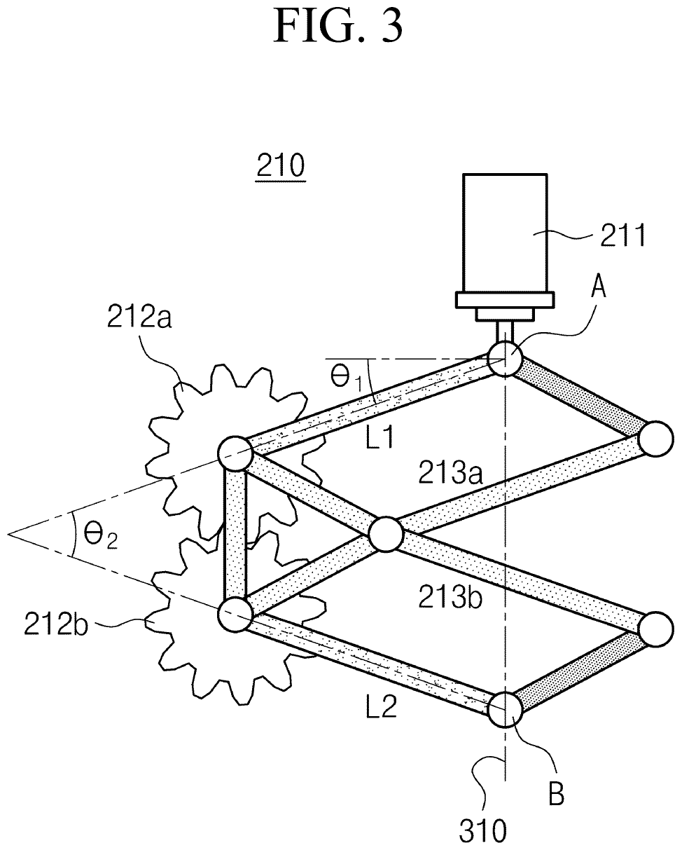

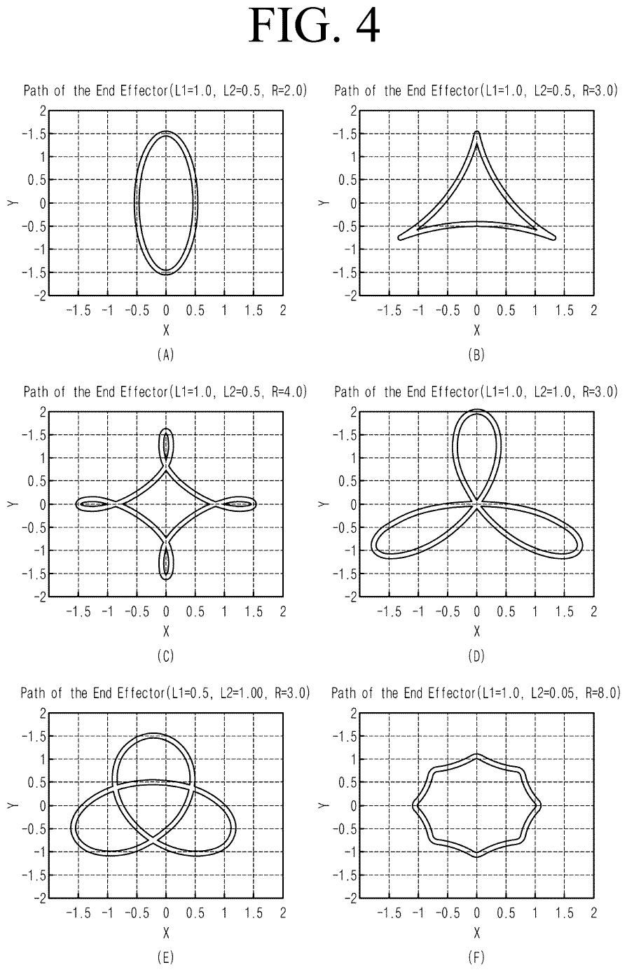

FIGS. 3 and 4 are views explaining conditions for supporting linear movement or curved movement of the manipulator robot in accordance with an embodiment of the present disclosure.

First, as shown in FIG. 3, it is assumed that the angle formed by the first link L1 with respect to a horizontal plane is a first angle θ1, and the angle between the first link L1 and the second link L2 is a second angle θ2.

In an embodiment of the present disclosure, conditions under which the manipulator robot performs linear movement may be determined under the above-described assumption.

### [Condition 1]

The two links L1 and L2 should have equal length (L1=L2).

### [Condition 2]

The ratio between the two angles θ1 and θ2 should be restricted to 2 (θ2=2 θ1).

Conditions 1 and 2 may be satisfied when the numbers of teeth of the two gears are equal.

When one or both of conditions 1 and 2 are not satisfied, the manipulator robot according to this embodiment may perform curved movement.

That is, the manipulator robot may be configured to perform curved movement under the following conditions.

### [Condition 3]

The two links have different lengths, respectively, to enable curved movement (L1≠L2).

### [Condition 4]

The ratio between the two angles should not be restricted to 2 ((θ2≠2 θ1).

That is, it may be possible to change a movement path of the manipulator robot by determining the numbers of teeth of the two gears to be different from each other.

A variety of curved movements may be realized, as shown in FIG. 4.

In detail, in examples of various movement trajectories of FIG. 4, “R” may be determined by the ratio between the two angles, as follows.

$$R = θ2 / θ1 \qquad [ Relation 1 ]$$

FIG. 4(A) shows a movement trajectory realized under conditions that L1=1.0, L2=0.5, and R=2.0. FIG. 4(B) shows a movement trajectory realized under conditions that L1=1.0, L2=0.5, and R=3.0.

FIG. 4(C) shows a movement trajectory realized under conditions that L1=1.0, L2=0.5, and R=4.0. FIG. 4(D) shows a movement trajectory realized under conditions that L1=1.0, L2=1.0, and R=3.0. FIG. 4(E) shows a movement trajectory realized under conditions that L1=0.5, L2=1.0, and R=3.0. FIG. 4(F) shows a movement trajectory realized under conditions that L1=1.0, L2=0.05, and R=8.0.

That is, the manipulator robot according to the present disclosure may realize a variety of movement trajectories even when a single motor is used. It can be seen that, when the above-described manipulator robot is used for realization of a variety of curved movements, condition 3 as described above should always be satisfied.

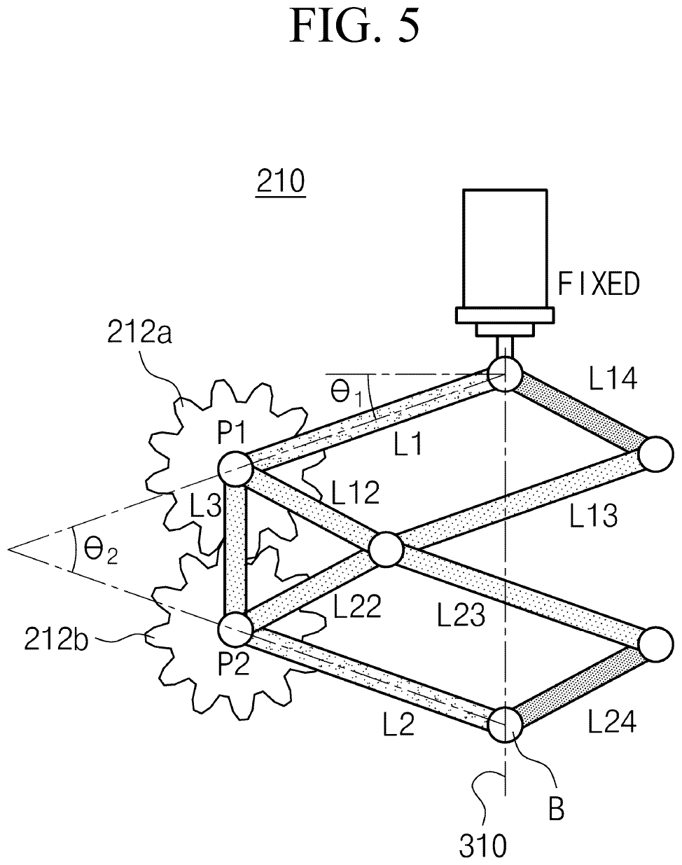

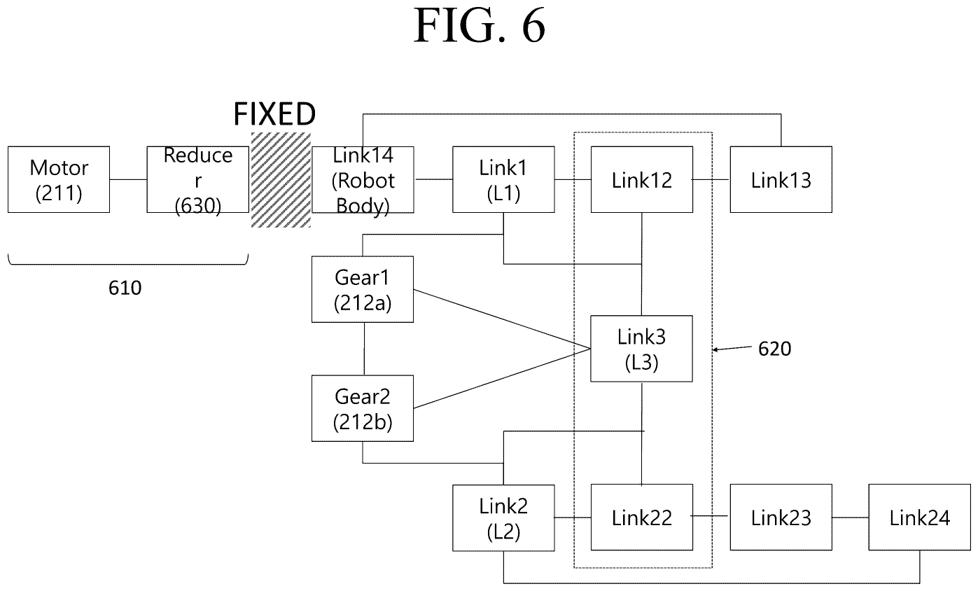

FIGS. 5 and 6 are views explaining a detailed configuration of a manipulator robot using two 4-bar links in accordance with an embodiment of the present disclosure.

First, as shown in FIG. 5, the first gear 212a and the second gear 212b may be configured to be connected to opposite sides of a third link L3, respectively.

In addition, the first link L1 may be connected, at the other side P1 thereof, to one side of the third link L3, together with the first gear 212a and one side of the 1-2th link L12 which is one link of the first 4-bar link 213a.

In addition, the second link L2 may be connected, at one side P2 thereof, to the other side of the third link L3, together with the second gear 212b and one side of the 2-2th link L22 which is one link of the second 4-bar link 213b.

In this case, in an embodiment of the present disclosure, it is proposed that the third link L3, the 1-2th link L12, and the 2-2th link L22 be disposed within a housing to constitute a signal part 620, as shown in FIG. 6.

The other side P1 of the first link L1 and the one side P2 of the second link L2 may be coupled to the above-described constituent elements by joints. Detailed coupling structures will be described in more detail later.

In addition, in the manipulator robot according to the embodiment of the present disclosure, the single motor 211 may be connected to the first 4-bar link 213a, in detail, the 1-4th link in the example of FIG. 6, via a reducer 630. In this case, the motor 211 and the reducer 630 are configured to be disposed in a robot body in a hidden state and, as such, constitute a part 610, thereby securing a space. In addition, the configuration from the motor 211 up to the reducer 630 may be disposed in a fixed structure, as shown in FIG. 6, and the 1-4th link may constitute a robot body and may realize movement of the manipulator robot in accordance with relative movement thereof with respect to the 2-4th link.

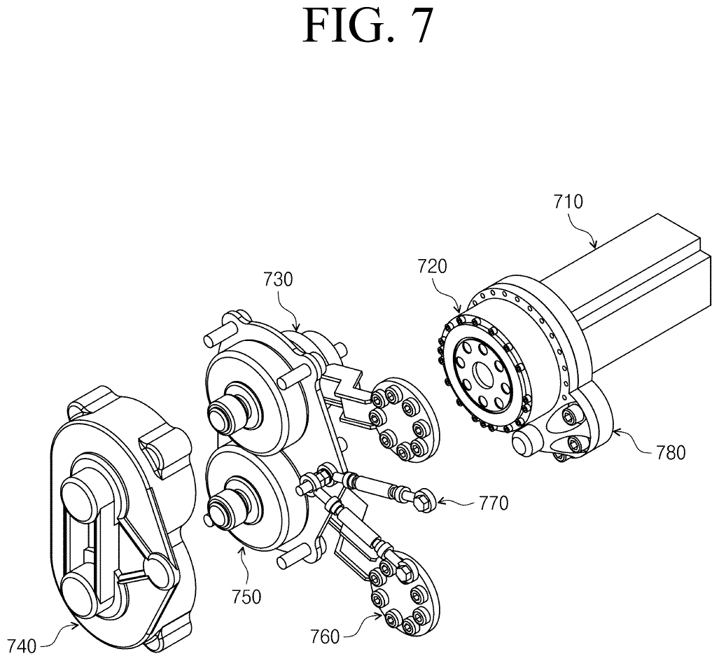

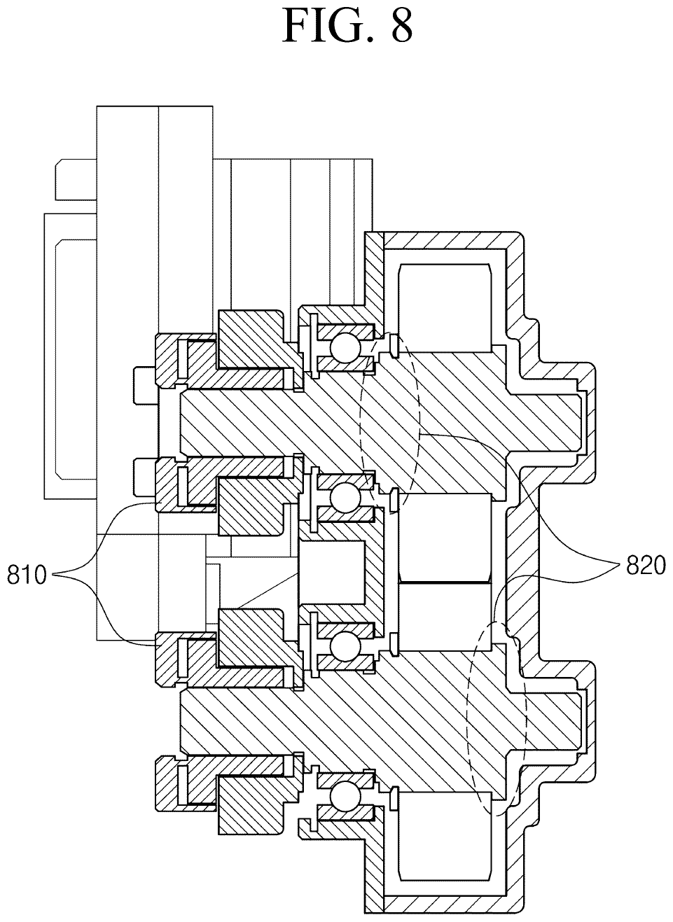

FIGS. 7 and 8 are views explaining configurations of parts of a manipulator robot according to an embodiment of the present disclosure.

First, referring to FIG. 7, an example in which a motor is implemented by a lift motor 710 in the manipulator robot according to this embodiment is shown. It is preferred that the lift motor 710 have a standard of DC24V and 200 W, a rated torque of 0.64 Nm, a rated speed of 4,000 RPM, and a rated current of 10.4 Arms.

In addition, the manipulator robot according to this embodiment may employ a reducer 720 of a harmonic drive type. Preferably, the redactor 720 has a reduction ratio of 160:1.

In addition, the manipulator robot according to this embodiment may include a mechanical lock 730. Here, the mechanical lock may also be referred to as “Mechalock” which is a trademark name. The mechanical lock 730 may be configured taking into consideration a phase difference caused by a first gear and a second gear, corresponding to first and second links. Through such a configuration, the manipulator robot according to this embodiment may overcome a gear phase difference. Preferably, the manipulator robot may be configured to obtain a maximum torque transmission of 115 Nm.

Reference numeral “810” in FIG. 8 illustrates a concrete structure for application of a mechanical lock. That is, it may be possible to enhance assemblability of the first link L1 and the second link L2 using the mechanical lock. That is, although there is an angle limit when simple bolting fastening is used, there may be an advantage in that a fastening angle is completely free, when the mechanical lock is applied.

In addition, the manipulator robot according to this embodiment may additionally include a gear housing 740 and, as such, the two gears may be spatially disposed like a single part.

Furthermore, in the manipulator robot according to this embodiment, each of the first gear and the second gear may be constituted by a helical gear 750. Preferably, the helical gear 750 may be configured to have a number of teeth corresponding to 30, a key type, and an LH and RH set.

Reference numeral “820” in FIG. 8 concretely illustrates a pin design structure taking into consideration an axial load of the helical gears. That is, the manipulator robot according to this embodiment may have an advantage in that it may be possible to transmit strong force using relatively small gears, in accordance with use of the helical gears. A pin design shown by reference numeral “820” in FIG. 8 is proposed in order to effectively receive a load axially applied when the helical gears are used.

Again referring to FIG. 7, the manipulator robot according to the embodiment of the present disclosure may be configured to include a main arm 760 and a sub-arm 770. The sub-arm 770 may have spherical bearing rod ends at opposite ends thereof, and it is preferred that the sub-arm 770 be adjustable in length.

In addition, the lift motor 710 may be configured to include a sub-arm upper end support 780 at one side thereof.

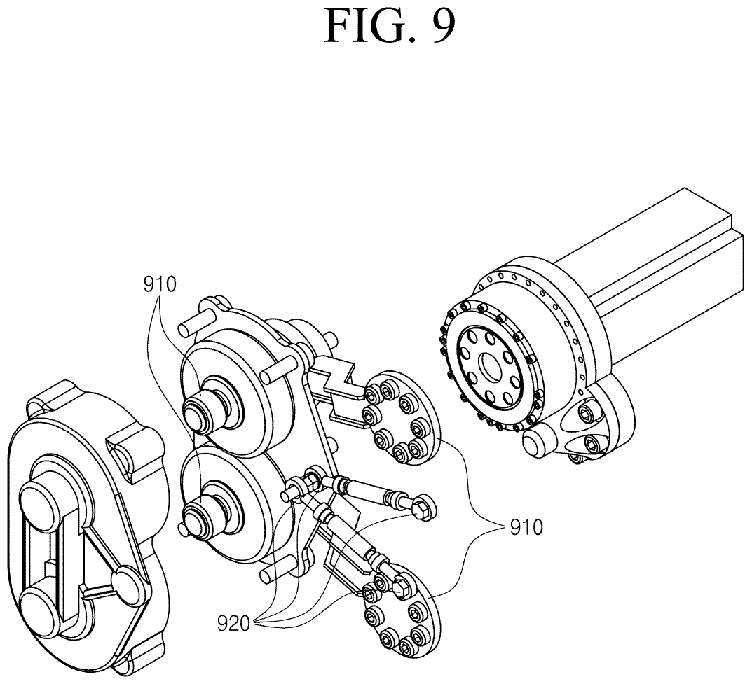

FIG. 9 is a view explaining a joint structure of the manipulator robot according to an embodiment of the present disclosure.

As described above with reference to FIGS. 5 and 6, the first link L1 may be connected, at the other side P1 thereof, to one side of the third link L3, together with the first gear 212a and one side of the 1-2th link L12 which is one link of the first 4-bar link 213a. In addition, the second link L2 may be connected, at one side P2 thereof, to the other side of the third link L3, together with the second gear 212b and one side of the 2-2th link L22 which is one link of the second 4-bar link 213b.

Such connection of the constituent elements may be achieved through the joint structure shown in FIG. 9.

In detail, the other side P1 of the first link L1 and the one side P2 of the second link L2 may be configured to be interconnected through a combination of a revolute joint 910 and a spherical joint 920.

Theoretically, there may be no problem in the case in which the above-described connection is achieved using only the revolute joint 910. However, elastic deformation or the like may be exhibited when an actual product is realized. Accordingly, it is more preferred that a combination of the revolute joint 910 with the spherical joint 920 be used, for an enhancement in degree of freedom.

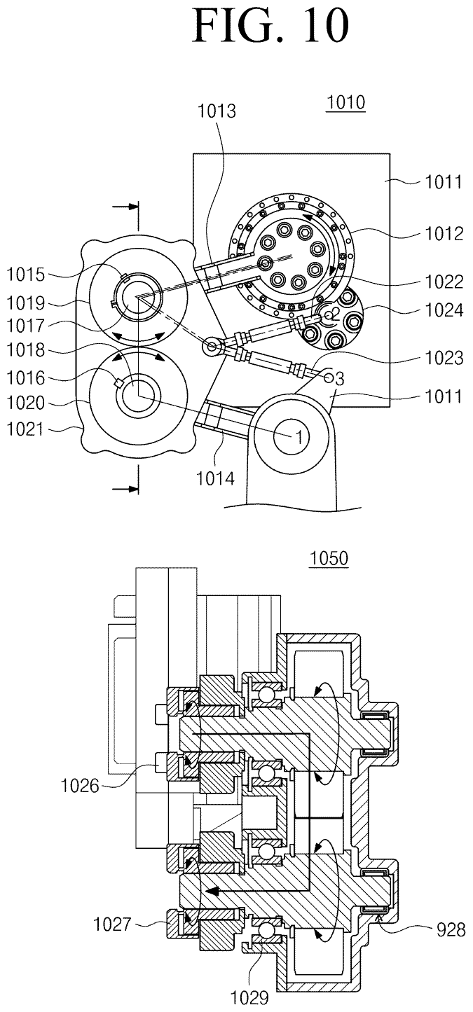

FIG. 10 is a view explaining a detailed structure of power transmission according to an embodiment of the present disclosure.

First, reference numeral “1010” in FIG. 10 designates a front view of a manipulator robot according to an embodiment of the present disclosure, and reference numeral “1050” in FIG. 10 designates a side view of the manipulator robot.

First, referring to the front view 1010 in FIG. 10, the manipulator robot may be disposed at a fixed part 1011 in a fixed state and may be disposed in a state in which a motor 1012, for example, a lift motor, is connected thereto.

Links of the robot may be distinguished in the form of arms and, as such, may be represented as an upper arm 1013 and a lower arm 1014. Gears connected to the links may be constituted by an upper gear key 1015, a lower gear key 1016, an upper axis 1017, a lower axis 1018, an upper gear 1019, and a lower gear 1020 and, as such, may be configured like a single part in accordance with disposition thereof in a housing 1021.

At the right side of the front view 101, reference numerals of an upper rod 1022, a lower rod 1023, an upper rod mount 1024, and an end effector 1025 are indicated.

Meanwhile, the side view 1050 shows a disposition structure of an upper mechanical lock 1026 and a lower mechanical lock 1027, and a lower end portion of FIG. 10 shows a disposition type of a needle bearing 1028 and a 4P bearing 1029.

In the disposition structure as described above, power transmission from the lift motor 1012 to the end effector 1025 is carried out in an order of the lift motor 1012→the upper arm 1013→the upper mechanical lock 1026→the upper axis 1017→the upper gear key 1015→the upper gear 1019→the lower gear 1020→the lower gear key 1016→the lower axis 1018→the lower mechanical lock 1027→the lower arm 1014→the end effector 1025, as indicated by a solid line in FIG. 10.

In addition, power transmission of drive power of the motor to the upper/lower rods may be carried out in an order of the lift motor 1012→the upper arm 1013→the housing 1021→the upper rod 1022→the upper rod mount 1024, as indicated by a dash-single dotted line in FIG. 10, and may also be carried out in an order of the lift motor 1012→the upper arm 1013→the housing 1021→the lower rod 1023→the end effector 1025, as indicated by a dash-double dotted line in FIG. 10.

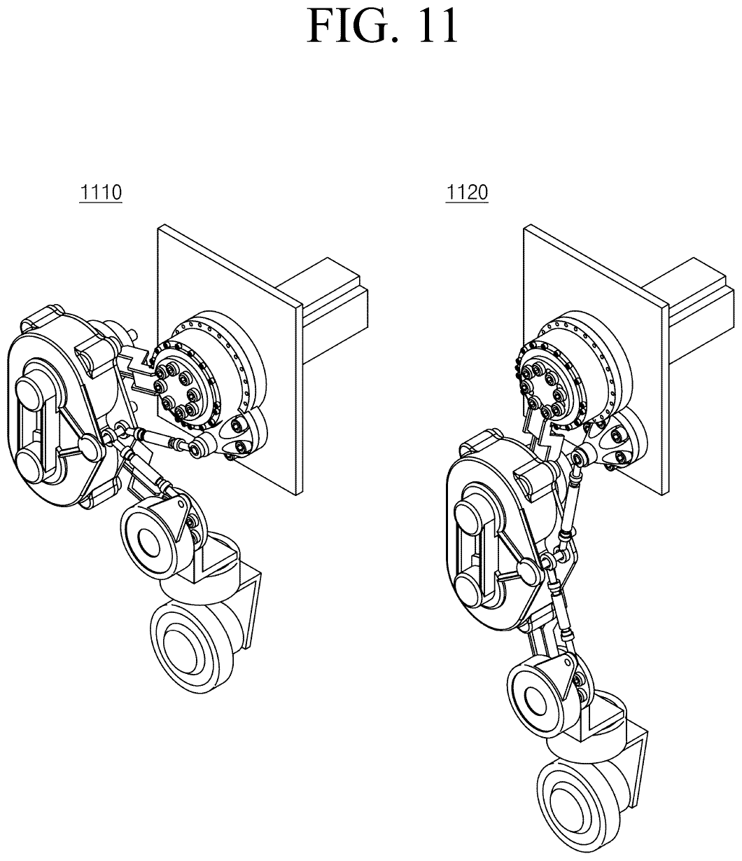

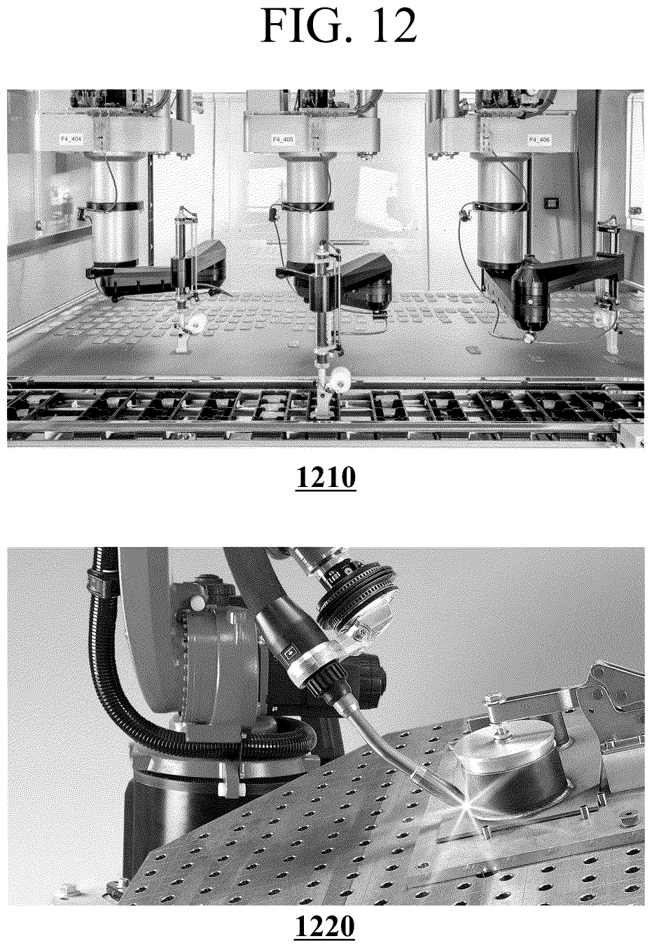

FIGS. 11 and 12 are views illustratively showing the fields in which manipulator robots according to embodiments of the present disclosure are usable.

First, FIG. 11 shows a use example in which a manipulator robot as described above is disposed at a lower end of a mobile robot to adjust a height of the mobile robot. Reference numeral “1110” in FIG. 11 shows a contracted state of the manipulator robot according to this embodiment, and reference numeral “1120” shows an extended state of the manipulator robot according to this embodiment.

In addition, as shown by reference numeral “1210” in FIG. 12, the manipulator robot may be provided with an end effector configured to perform pick and place operations and, as such, may be optimally used on a factory conveyor belt. Trajectories of the pick and place operations as described above may be set to be a variety of trajectories as well as the linear trajectory described above with reference to FIG. 4.

In addition, the manipulator robot may be used in cutting and welding operations, as shown by reference numeral “1220” in FIG. 12. As described above, the manipulator robot is usable in an area where a nonlinear curve is required in cutting and welding operations.

The manipulator robot according to each of the embodiments of the present disclosure described above may be diversely used in fields substitutable for fields in which existing 2-degree-of-freedom manipulator robots are used, even though the manipulator robot has a simple configuration.

As apparent from the above description, in accordance with the embodiments of the present disclosure as described above, it may be possible to provide a manipulator robot in which a robot structure constituted by two 4-bar links is simplified using a single driver.

In addition, it may be possible to realize more stable robot operation by proposing a concrete configuration using 4-bar links, which is capable of performing stable operation when the configuration is applied to an actual product, beyond the method in which two links are controlled using a single motor, simply and only taking kinematics into consideration.

Furthermore, it may be possible to realize a manipulator robot capable of providing a variety of curved movements as well as linear movement by appropriately setting a length and an angle between particular links of two 4-bar links of the manipulator robot.

Effects attainable in the present disclosure are not limited to the above-described effects, and other effects of the present disclosure not yet described will be more clearly understood by those skilled in the art from the above detailed description.

The detailed description of the preferred embodiments of the present disclosure disclosed as above is provided to enable those skilled in the art to easily embody and implement the present disclosure. Although the preferred embodiments of the present disclosure have been described in the above description, those having ordinary knowledge in the technical field to which the present disclosure pertains will appreciate that various modifications and changes are possible, without departing from the scope of the present disclosure. For example, those skilled in the art may use configurations described in the above-described embodiments through a combination thereof.

Accordingly, the present disclosure is intended to provide a widest scope matching with principles and new features disclosed herein.

What is claimed is:

1. A manipulator robot comprising:
a first 4-bar link;
a second 4-bar link configured to move symmetrically with the first 4-bar link;
a single motor connected to one of the first 4-bar link and the second 4-bar link to supply driver power to the first 4-bar link and the second 4-bar link; and
a rotation mechanism configured to interconnect the first 4-bar link and the second 4-bar link to transmit drive power supplied to one of the first 4-bar link and the second 4-bar link to the other of the first 4-bar link and the second 4-bar link.

2. The manipulator robot according to claim 1, wherein the rotation mechanism comprises:
a first gear configured to rotate in accordance with drive power supplied to the first 4-bar link; and
a second gear configured to rotate, corresponding to rotation of the first gear.

3. The manipulator robot according to claim 2,
wherein the first 4-bar link comprises a first link connected to the single motor at one side thereof while being connected to the first gear at another side thereof, and
wherein the second 4-bar link comprises a second link connected to the second gear at one side thereof and configured to move symmetrically with the first link.

4. The manipulator robot according to claim 3, wherein, assuming that an angle formed by the first link with respect to a horizontal plane is a first angle (θ1), and an angle between the first link and the second link is a second angle (θ2), the other side of the second link is configured to move along a linear path with respect to the one side of the first link in response to a first condition that the first link and the second link have equal length and a second condition that the second angle corresponds to double the first angle being satisfied.

5. The manipulator robot according to claim 3, wherein, assuming that an angle formed by the first link with respect to a horizontal plane is a first angle (θ1), and an angle between the first link and the second link is a second angle (θ2), the other side of the second link is configured to move along a curved path with respect to the one side of the first link in response to one or both of a first condition that the first link and the second link have equal length and a second condition that the second angle corresponds to double the first angle not being satisfied.

6. The manipulator robot according to claim 3,
wherein the first gear and the second gear are connected to opposite sides of a third link, respectively,
wherein the first link is connected, at the other side thereof, to one side of the third link, together with the first gear and one side of a 1-2th link which is one link of the first 4-bar link, and
wherein the second link is connected, at the one side thereof, to another side of the third link, together with the second gear and one side of a 2-2th link which is one link of the second 4-bar link.

7. The manipulator robot according to claim 6, wherein the third link, the 1-2th link, and the 2-2th link are disposed within a housing to constitute a signal part.

8. The manipulator robot according to claim 6, wherein the other side of the first link and the one side of the second link are configured to be interconnected through a combination of a revolute joint and a spherical joint.

9. The manipulator robot according to claim 3, further comprising:
a mechanical lock configured to take into consideration a phase difference caused by the first gear and the second gear, corresponding to the first link and the second link.

10. The manipulator robot according to claim 3, wherein each of the first gear and the second gear comprises a helical gear.

11. The manipulator according to claim 1, wherein the single motor is connected to one of the first 4-bar link and the second 4-bar link via a reducer.

12. A manipulator robot comprising:
a first 4-bar link;
a second 4-bar link configured to move symmetrically with the first 4-bar link;
a single motor connected to one of the first 4-bar link and the second 4-bar link to supply driver power to the first 4-bar link and the second 4-bar link;
a rotation mechanism configured to interconnect the first 4-bar link and the second 4-bar link to transmit drive power supplied to one of the first 4-bar link and the second 4-bar link to the other of the first 4-bar link and the second 4-bar link; and
a controller configured to:
control the single motor; and
control the rotation mechanism to drive the first 4-bar link and the second 4-bar link to move with a 1-degree-of-freedom.

13. The manipulator robot according to claim 12, wherein the 1-degree-of-freedom movement includes linear movement.

14. The manipulator robot according to claim 12, wherein the rotation mechanism comprises:
a first gear configured to rotate in accordance with drive power supplied to the first 4-bar link; and
a second gear configured to rotate, corresponding to rotation of the first gear.

15. The manipulator according to claim 12, wherein the single motor is connected to one of the first 4-bar link and the second 4-bar link via a reducer.
